(19) United States
(12) Patent Application Publication
(10) Pub. No.: US 2005/0204626 A1
(43) Pub. Date: Sep. 22, 2005

(54) Reforming module for converting hydrocarbon-containing fuel gases to hydrogen-containing process gases

(76) Inventors: Miroslav Podhorsky, Ratingen (DE); Albrecht Brenner, Haren (DE)

Correspondence Address: BAKER & HOSTETLER LLP;Washington Square, Suite 1100, 1050 Connecticut Avenue, N.W., WASHINGTON, DC, 20036, US

(21) Appl. No.: 10/937,259

(22) Filed: Sep. 10, 2004

(30) Foreign Application Priority Data
Sep. 15, 2003 (EP) 03020855.7

(51) Int. Cl. B01J 8/02

(52) U.S. Cl. 48/127.9; 422/198; 422/211

(57) ABSTRACT

The invention relates to a reforming module for converting hydrocarbon-containing fuel gases to hydrogen-containing process gases, wherein the catalytic reaction occurs on the surface of a plate catalyst, said module constructed such that the hydrocarbon-containing fuel gas before entering the catalyst chamber flows through a tubular heat exchanger by means of which the hydrocarbon-containing fuel gas is preheated through utilization of the heat content of the reformed process gas and that the catalyst-bearing plates are designed in the form of heat exchangers, through which flow the cathode waste gas and the waste gases from a catalytic combustion chamber, in which the residual amounts of hydrogen, carbon dioxide, and carbon monoxide, present in the process gas, are combusted catalytically after the electrochemical process. In particular, the reforming module of the invention is distinguished in that it has a bypass inlet to an upstream tubular heat exchanger, through which cold hydrocarbon-containing fuel gas can be passed into the catalyst chamber. This offers the advantage of optimal process control of the catalytic reforming process without affecting the total volumetric flow.

The invention relates to a reforming module for converting hydrocarbon-containing fuel gases to hydrogen-containing process gases, the catalytic conversion occurring on the surface of a plate catalyst.

Fuel cells with a modern configuration are excellently suitable due to their compact design for a centralized or decentralized supplying of energy. Customarily, modern fuel cells, such as, e.g., molten carbonate fuel cells (MCFC) or solid oxide fuel cells (SOFC), are operated with hydrogen. The use of such fuel cells in mobile units in particular is burdened with the hydrogen supply problem. As is generally known, the transport of hydrogen poses a safety and storage engineering problem. Hydrogen both in compressed gas tanks and deep-frozen in suitable insulated tanks also harbors a very great potential hazard. Moreover, the transportable volumes are usually very small, which when a fuel cell is used in automotive engineering, for example, leads to very limited cruising ranges.

A better option for supplying the fuel cell with hydrogen-containing process gas, therefore, is the reforming of hydrocarbon-containing compounds into hydrogen-containing process gas.

This type of reforming can occur in different ways. On the one hand, the hydrogen-containing compounds can be converted to hydrogen-containing process gases in external reforming reactors. This has the disadvantage, however, that the high amount of energy necessary for this endothermic process must be provided and the overall energy balance of the fuel cell unit worsens considerably.

It has been known for many years during the development of fuel cells that the heat, obtained in the electrochemical reaction in the fuel cell, is sufficient to sustain the endothermic reforming of hydrocarbon into hydrogen-containing process gas. This finding led to numerous concepts for the internal reforming of hydrocarbons, which are applied in SOFC and MCFC—promoted by their high working temperatures. The concepts on internal reforming basically differentiated two variants, direct internal reforming (DIR) and indirect internal reforming (IIR), which is also called integrated reforming.

Indirect internal reforming (IIR) comprises the reaction of high hydrocarbons on a reforming catalyst, which is in close thermal contact with the fuel cell stack but spatially separated from it. IIR can be structurally realized, on the one hand, by a plate reformer in contact with the cells of a fuel cell stack. The reformate from each plate is then passed into the stack. On the other hand, the reforming catalyst can be applied in the gas distribution of each individual cell of a stack. In so doing, the close thermal contact between the reformer and fuel cell stack has a positive effect. It is frequently disadvantageous that the heat of the reaction from the electrochemical fuel cell reaction can be released in sufficient amounts only by the cells that are located in the immediate vicinity of the reformer.

In direct internal reforming (DIR), the reforming reaction occurs within the anode of the fuel cell. In the case of MCFC, this is realized by placing the reforming catalyst in the channels of the fuel cell. In the SOFC, the operating temperature is so high that the reforming of the hydrocarbon-containing compound can be performed directly at the anode of the fuel cell, which in addition has a sufficiently high nickel content for this. The advantage of DIR versus IIR or external reforming is the good and direct transfer of heat between the fuel cell stack and reforming zone and the high degree of chemical integration. Steam as a product of the electrochemical reaction in the cell can be coupled in directly as a starting product of the reforming reaction, so that less steam for reforming must be produced in comparison with IIR, thus improving the electrical efficiency of the fuel cell. The amount of heat produced by the electrochemical reaction in the fuel cell is approximately twice the heat requirement of the reforming reaction. The good heat transfer between reforming and cell in DIR greatly simplifies the cooling of the fuel cell, which is conventionally realized by passing a large gas stream through the cell. These measures also improve the electrical efficiency of the entire system in comparison with IIR. Other advantages of DIR versus IIR and, in particular, external reforming are: reduced system costs because a special separate reforming apparatus is not necessary; more homogeneous hydrogen formation resulting in more uniform temperature distribution; and a higher hydrocarbon conversion.

However, internal reforming also has great disadvantages. Thus, for example, the hardware of the fuel cell stack must be modified so that the reforming catalyst can be introduced. The reforming catalyst can be deactivated by impurities in the fuel or by sintering processes, which can lead to failure of the entire fuel cell stack. The integration of two functions—electrochemical reaction and reforming—can reduce flexibility during fuel cell operation. Complete internal reforming can lead to carbon deposits in the anode compartment, which deactivate the reforming catalyst. Furthermore, during complete internal reforming, high temperature gradients arise in the region of the fuel inlet because of the extensive cooling effect of reforming due to its very rapid reaction rate. This leads to strong thermal stressing of the materials of the fuel cell. Primarily the starting up of fuel cells with integrated reforming often proves problematic, because the energy necessary for the reforming must be supplied to the entire fuel cell stack from the outside.

The object of the invention is to provide a reformer unit for reforming hydrocarbon-containing fuel into hydrogen-containing process gas, while avoiding the aforementioned disadvantages, said unit which combines the advantages of external reforming in regard to flexibility and modularity with the advantages of intimate thermal contact, as occurs in internal reforming.

As taught by the invention, this object is achieved in that a reforming module for converting hydrocarbon-containing fuel gases to hydrogen-containing process gases, wherein the catalytic reaction occurs on the surface of a plate catalyst, is constructed such that the hydrocarbon-containing fuel gas before entering the catalyst chamber flows through a tubular heat exchanger by means of which the hydrocarbon-containing fuel gas is preheated through utilization of the heat content of the reformed process gas and in that the catalyst-bearing plates are designed in the form of heat exchangers, through which flow the cathode waste gas and the waste gases from a catalytic combustion chamber, in which the residual amounts of hydrogen, carbon dioxide, and carbon monoxide, present in the process gas, are combusted catalytically after the electrochemical process.

In particular, the reforming module of the invention is distinguished in that the module has a bypass inlet to an upstream tubular heat exchanger, through which cold hydrocarbon-containing fuel gas can be passed into the catalyst chamber. This offers the advantage of optimal process control of the catalytic reforming process without affecting the total volumetric flow.

Advantageously, the waste gases from the fuel cell and the waste gases from the catalytic combustion chamber are transported with the aid of a fan through the catalyst carrier, constructed in the form of a plate heat exchanger, to assure optimal utilization of the energy contained in the waste gases.

To utilize optimally the radiant heat as well of the electrochemical process in the fuel cell, the reformer module is advantageously connected by means of a large area to the fuel cell.

To assure the greatest possible flexibility and redundancy, both the tubular heat exchanger unit for preheating the hydrocarbon-containing fuel gases and also the catalyst carrier in the form of a plate heat exchanger are designed modularly and can be changed individually.

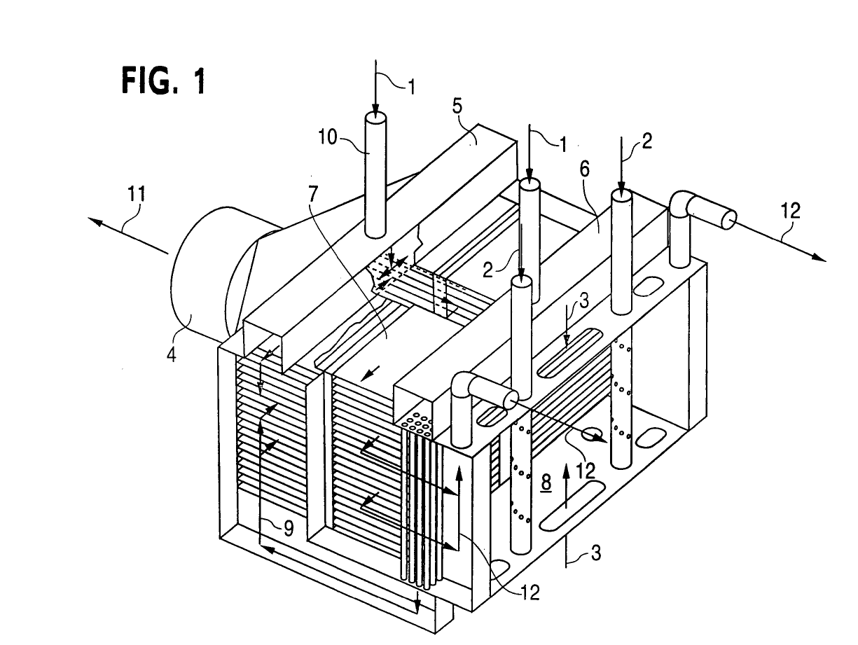

FIG. 1 shows an advantageous embodiment of a reformer module of the invention, but is not limiting in nature.

Hydrocarbon-containing fuel gas (1) enters the tubular heat exchanger module (6) and flows, as represented by the gas stream (9), into a plate catalyst module (7). In the tubular heat exchanger module (6), the heat energy contained in the hydrogen-containing process gas (12) after the reforming is utilized for preheating the hydrocarbon-containing fuel gas (1). It is reformed into a hydrogen-containing process gas (12) in the plate catalyst module (7), with utilization of the waste heat arising due to the catalytic combustion of the anode (2) and cathode gases (3) in the catalytic combustion chamber (8). For optimal utilization of the energy obtained in the catalytic combustion chamber (8), the waste gases are drawn off from said chamber by means of a fan (4) and passed through the plate catalyst module (7). Next, they flow out as waste gas (11). For optimal temperature control within the reformer module, said module has a bypass inlet for cold hydrocarbon-containing fuel gas (10) and a suitable gas distribution (5).

Reference Number List

1. Hydrocarbon-containing fuel gas
2. Anode waste gas
3. Cathode waste gas
4. Fan
5. Gas distribution bypass
6. Tubular heat exchanger module
7. Plate catalyst module
8. Catalytic combustion chamber
9. Fuel gas stream after the tubular heat exchanger
10. Bypass inlet for cold hydrocarbon-containing fuel gas
11. Waste gas stream after the fan
12. Hydrogen-containing process gas to the fuel cell

1. Reforming module for converting hydrocarbon-containing combustible gases to hydrogen-containing process gases, wherein the catalytic conversion occurs on the surface of a plate catalyst,
characterized in that
the hydrocarbon-containing fuel gas before entering the catalyst chamber flows through a tubular heat exchanger by means of which the hydrocarbon-containing fuel gas is preheated through utilization of the heat content of the reformed process gas, and that the catalyst-bearing plates are designed in the form of heat exchangers, through which flow the cathode waste gas and the waste gas from a catalytic combustion chamber, in which the residual amounts of hydrogen, carbon dioxide, and carbon monoxide, present in the process gas, are combusted catalytically after the electrochemical process.

2. Reformer module according to claim 1, characterized in that the reformer module has a bypass inlet to an upstream tubular heat exchanger through which cold hydrocarbon-containing fuel gas can be passed into the catalyst compartment.

3. Reformer module according to claim 1, characterized in that the fuel cell waste gases and the waste gases from the catalytic combustion chamber are transported with aid of a fan, drawing off the waste gases, through a catalyst carrier constructed in the form of a plate heat exchanger.

4. Reformer module according to claim 1, characterized in that the reformer module to utilize the waste heat of the electrochemical process is connected by means of a large area to the fuel cell.

5. Reforming module according to claim 1, characterized in that the tubular heat exchanger can be replaced as a module.

6. Reformer module according to claim 1, characterized in that the plate condensers, constructed in the form of a plate-shaped heat exchanger, can be replaced modularly.
